(19) United States
(12) Patent Application Publication
(10) Pub. No.: US 2026/0133908 A1
(43) Pub. Date: May 14, 2026

(54) DYNAMIC KEY VALUE PAIR CACHE SCHEDULING

(71) Applicant: NVIDIA Corporation, Santa Clara, CA (US)

(72) Inventors: Bingyao Li, Lowell, MA (US); Aamer Jaleel, Northborough, MA (US); Po-An Tsai, Somerville, MA (US); Anish Saxena, Merrimack, NH (US)

(21) Appl. No.: 19/053,282

(22) Filed: Feb. 13, 2025

Related U.S. Application Data
(60) Provisional application No. 63/718,997, filed on Nov. 11, 2024.

(51) Int. Cl. G06F 12/0811

(52) U.S. Cl. CPC G06F 12/0811

(57) ABSTRACT

Managing memory when processing a large language model (LLM) using a multi-turn interaction framework can be difficult as the LLM can produce significantly more key-value (KV) pairs than can be stored in a processor's memory. The multi-turn framework allows the LLM to process information more efficiently using the KV pairs. The KV pairs can be cached, such as in a KV cache. Policies can be used to identify KV pairs that should remain in the cache, KV pairs that can be moved to a more distant cache, or KV pairs that can be discarded. These policies can assist in managing the memory so the most valuable KV pairs for LLM processing efficiency remain in the processor's local cache memory. More distant cache can be memory locations outside of the processor, or in memory stacks connected via a communication bus.

### CROSS-REFERENCE TO RELATED APPLICATION

This application claims the benefit of U.S. Provisional Application Ser. No. 63/718,997, filed by Li, et al., on Nov. 11, 2024, entitled “DYNAMIC KEY VALUE PAIR CACHE SCHEDULING,” commonly assigned with this application and incorporated herein by reference in its entirety.

### TECHNICAL FIELD

This application is directed, in general, to improving the operation of large language models and, more specifically, to managing processor memory.

### BACKGROUND

When implementing large language models (LLM), there can be inefficiencies introduced through the tracking and storage of key value (KV) pairs. As the number of KV pairs increases, memory constraints can become apparent in the system. The processor executing the LLM has a limited amount of L1 and L2 cache, as well as processor memory, to store KV pairs while the processing of input data is being performed. Some solutions have been proposed such as KV cache offloading or KV cache compression to address memory capacity issues. These solutions may not properly identify critical KV pairs that can be offloaded or discarded. Improving the handling of storing KV pairs would be beneficial to LLM processing.

### SUMMARY

In one aspect a method is disclosed. In one embodiment, the method includes (1) identifying two or more key-value (KV) caches capable of storing KV pairs, (2) implementing a KV hierarchy for the two or more KV caches, where at least one KV cache of the two or more KV caches is located on a processor and another KV cache of the two or more KV caches is located off the processor, and (3) processing a large language model (LLM) using a multi-turn interaction framework, wherein the processing computes the KV pairs and the KV pairs are used by the LLM in determining an LLM result, further including (3a) storing the KV pairs being used for a current turn interaction in the at least one KV cache located on the processor, (3b) freeing a memory capacity of the at least one KV cache located on the processor, using the KV hierarchy, through identifying a subset of KV pairs from the KV pairs to be removed from the at least one KV cache located on the processor, and (3c) reloading at least one KV pair from the set of KV pairs to the at least one KV cache located on the processor at a time when the processing needs the at least one KV pair for the current turn interaction.

In a second aspect, a system is disclosed. In one embodiment the system includes (1) a memory unit, capable of storing one or more key-value (KV) pairs in at least one off-processor KV cache, and (2) a processing unit capable of executing code to process a large language model (LLM) using a multi-turn interaction framework, wherein the processing unit is communicatively coupled to the memory unit, and further includes (2a) an on-processor KV cache capable of storing the one or more KV pairs, and (2b) a KV hierarchy unit capable of evaluating each KV pair in the one or more KV pairs to determine a movement of the each KV pair to remain in the on-processor KV cache, to move to the memory unit, or to be discarded.

In a third aspect, a non-transitory computer program product having a series of operating instructions stored on a non-transitory computer-readable medium that directs a key-value (KV) hierarchy when executed thereby to perform operations. In one embodiment, the operations include (1) identifying two or more KV caches capable of storing KV pairs, (2) implementing the KV hierarchy for the two or more KV caches, where at least one KV cache of the two or more KV caches is located on a processor and another KV cache of the two or more KV caches is located off the processor, and (3) processing a large language model (LLM) using a multi-turn interaction framework, wherein the processing computes the KV pairs and the KV pairs are used by the LLM in determining an LLM result, further including (3a) storing the KV pairs being used for a current turn interaction in the at least one KV cache located on the processor, (3b) freeing memory capacity of the at least one KV cache located on the processor, using the KV hierarchy, through identifying a subset of KV pairs from the KV pairs to be removed from the at least one KV cache located on the processor, and (3c) reloading at least one KV pair from the set of KV pairs to the at least one KV cache located on the processor at a time when the processing needs the at least one KV pair for the current turn interaction.

In a fourth aspect, a processing unit is disclosed. In one embodiment, the processing unit includes (1) a code execution module, capable of processing input data to a large language model (LLM) and generating an output of the LLM, wherein the LLM utilizes a multi-turn interaction framework, (2) a processor memory capable of storing one or more key-value (KV) pairs computed by the LLM in a KV cache, and (3) a KV hierarchy unit, capable of determining a storage location of the one or more KV pairs, wherein the storage location can be one of the KV cache of the processing unit, a second processor KV cache, or a memory unit KV cache, wherein the KV hierarchy utilizes a re-compute cost function and a reload cost function.

In a fifth aspect, a processing unit system is disclosed. In one embodiment, the processing unit system includes (1) a code execution system, capable of processing input data to a large language model (LLM) and generating an output of the LLM, wherein the LLM utilizes a multi-turn interaction framework, (2) a key-value (KV) cache system, part of a first processor, capable of storing one or more KV pairs computed by the LLM, and (3) a KV hierarchy system, capable of determining a storage location of the one or more KV pairs, wherein the storage location can be one of a first processor KV cache, a second processor KV cache, or a memory unit KV cache, wherein the KV hierarchy utilizes a re-compute cost function and a reload cost function.

### BRIEF DESCRIPTION

Reference is now made to the following descriptions taken in conjunction with the accompanying drawings, in which:

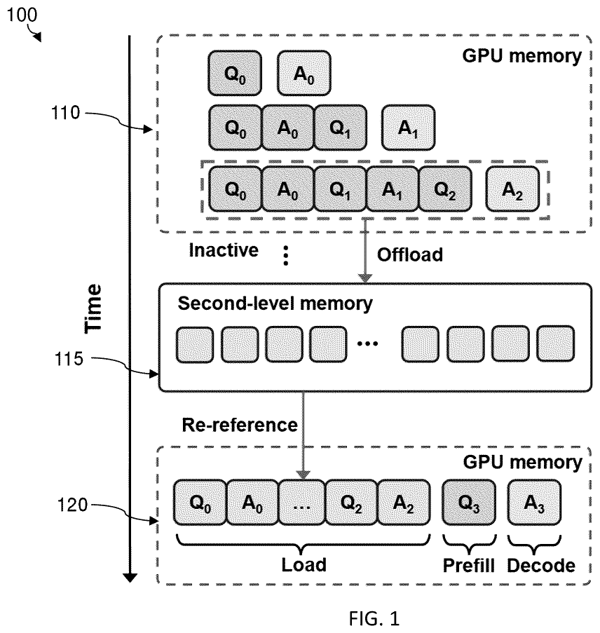

FIG. 1 is an illustration of a diagram of example KV pair flow for offloading and reloading;

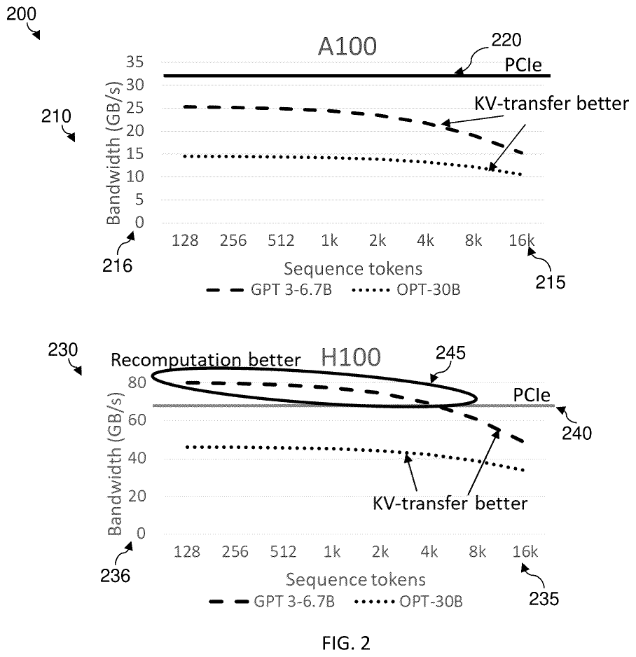

FIG. 2 is an illustration of a diagram of example graphs demonstrating the processes on a sample test machine;

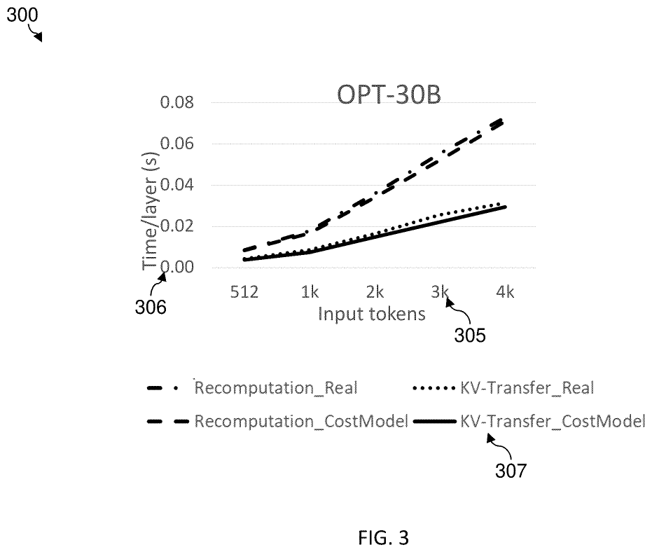

FIG. 3 is an illustration of a diagram of an example graph demonstrating the performance of the disclosed processes;

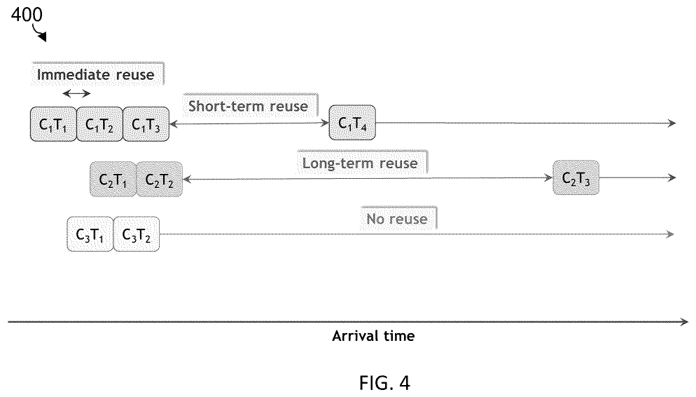

FIG. 4 is an illustration of a block diagram of an example graph demonstrating the relative time frames for storing KV pairs;

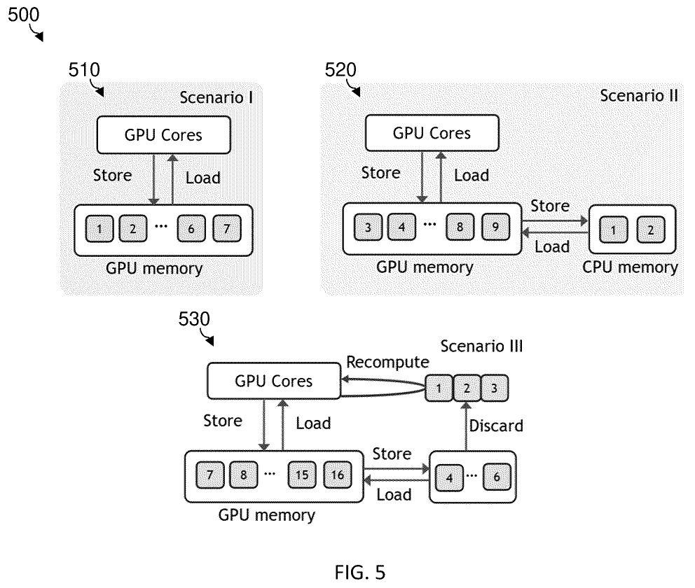

FIG. 5 is an illustration of a diagram of an example scenario flow showing three scenarios for storing a KV pair;

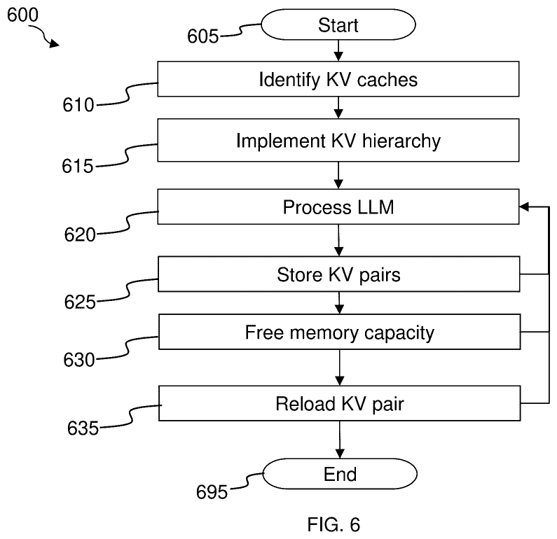

FIG. 6 is an illustration of a flow diagram of an example method to use a KV hierarchy process to manage KV pairs during processing of an LLM with a multi-turn interaction framework;

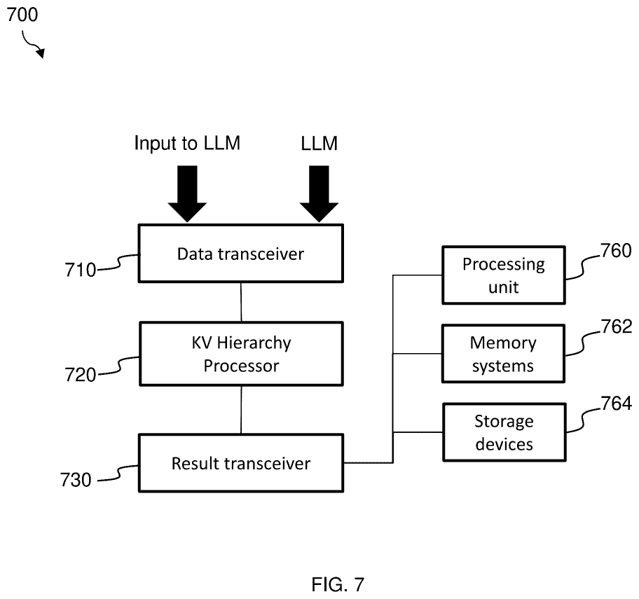

FIG. 7 is an illustration of a block diagram of an example KV hierarchy system; and

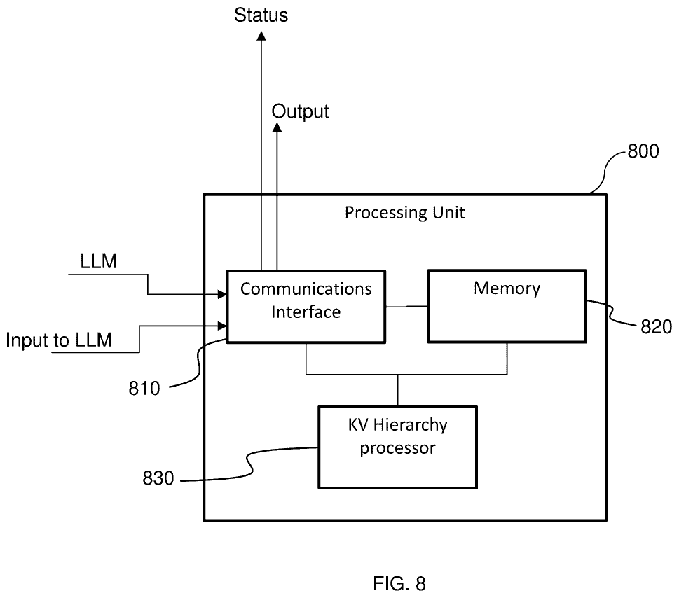

FIG. 8 is an illustration of a block diagram of an example of a KV hierarchy controller according to the principles of the disclosure.

### DETAILED DESCRIPTION

The landscape of artificial intelligence (AI) is quickly evolving. These advanced applications can harness multiple models in complex structures, such as multiturn interactions and branching pathways. Within this framework, multi-turn interactions can be used, enabling large language models (LLMs) to tackle sophisticated tasks with increased precision and relevance. Executing multi-turn interaction in LLM inference models may not be efficiently processed. Due to the limited capacity of processor memory, the key-value (KV) pairs of previous turns can be discarded after one or more turns complete their processing. As interactions progress, the discarding action can lead to a large amount of re-computation of previous KV pairs. The re-computation process of the KV pairs can be time-consuming, resulting in longer prefill latencies and a decline in Time to First Token (TTFT) performance. Therefore, developing an efficient KV cache hierarchy can be used to improve the efficiency of handling KV pairs, such as to retain and reuse KV pairs in multi-turn interactions to reduce prefill overheads.

The processor used to execute the code for the LLM processing model can be of various types, such as a central processing unit (CPU), a graphics processing unit (GPU), a single instruction multiple data (SIMD) processor, or other types of processors. The processors can have at least some internal memory locations, e.g., cache or processor memory, available to store KV pairs. The cache can be an L1 cache, an L2 cache, or other memory locations. Memory locations can be located proximate to the processor, such as with a nearby one or more processors, logic chips, or memory chips. Memory locations can be located along a communication bus, such as in a memory module or other memory storage device.

Prior work, such as infiniGen and Keyformer, have explored strategies such as KV cache offloading and KV cache compression to address memory capacity issues during LLM processing. These approaches can transfer data to secondary memory or discard the KV pairs entirely, while preserving only the most crucial KV pairs. It can be challenging to identify the data to maintain high accuracy. The complexity can be compounded by the fact that the significance of KV pair data can vary across different layers, iterations, or user queries. This variability can make it difficult to implement a solution that consistently achieves high accuracy. Existing platforms such as TensorRT-LLM offer an offloading solution. It can be limited to just two interaction turns. The typical use case can involve more than two turns, requiring a more adaptable and extensive approach.

Multi-turn interactions can be used across various agentic and compound AI applications, as they can allow the models to process and build upon information over a sequence of exchanges, rather than treating each query in isolation. This capability can be used for complex applications that benefit from retaining context and a deeper comprehension of past interactions, such as those in dialog systems, personalized recommendations, and complex question-answering scenarios. In such environments, the volume and complexity of information stored as the KV pairs can increase significantly. Maintaining the KV pairs in a memory cache can improve operational efficiency, as it can help ensure that the models provide contextually accurate and coherent responses. Proper KV cache management can be a key factor in enhancing the performance and scalability of LLMs in real-world applications.

This disclosure presents processes to implement a KV hierarchy that can maintain a KV cache while reducing the use of compression or pruned KV pairs. The disclosed processes can provide improvement in access to the KV pairs while maintaining high accuracy since the KV cache is not compressed or pruned. Due to limited processor memory capacity, the KV pairs in the KV cache can be offloaded from previous interactions to host memory. In some aspects, for large models such as OPT-30B, transferring the KV pairs over the PCIe (e.g., 4th generation with 16 lanes or higher) interconnect can provide significant performance benefits compared to KV cache re-computation.

The available PCIe bandwidth, re-computation overheads, and system performance can vary based on model size, input length, and system configurations. In some aspects, a runtime decision-making framework that determines whether to re-compute KV pairs in the KV cache or offload it to host memory can be part of the disclosed processes.

The reference interval of interactions in multi-turn conversations can vary. In some aspects, the disclosed processes can implement one or more KV cache scheduling policies. A policy can be for GPU caching for immediate reuse during ongoing interaction. A policy can be for Off-GPU caching for short-term reuse where the KV pairs of the KV cache are temporarily offloaded to host memory and reloaded when requested after brief intervals. A policy can be for No-Caching for long-term reuse or no-reuse where the KV pairs are removed after the interaction becomes inactive or ends. In some aspects, the policy can include performing KV pair re-computation upon re-reference.

The cost model for determining whether to hold a KV pair in the processor cache, to offload the KV pair to an off-processor cache, or to discard the KV pair can use different algorithms. One or more subsets of KV pairs can be identified in the KV cache, where each subset can be handled differently, such as being kept in the KV cache, being offloaded, or being discarded. The cost model can represent the cost to re-compute the KV pair (e.g., a re-compute cost function for a candidate KV pair) or to reload the KV pair (e.g., a reload cost function for a candidate KV pair) The cost model can be used to determine the freeing of memory capacity of the KV cache by offloading or discarding KV pairs. For example, a cost model for deep learning can use an 8-bit floating point format (FP8), as shown in Equation Set 1. A 16-bit floating point format (FP16) is shown in Equation Set 2.

$$Equation Set 1 : Example FP 8 cost function algorithm$$

$${KVCache}_{token} = 2 * b * l * {h}_{1}$$

$${KVCache}_{l a y e r} = 2 * b * {h}_{1} * s$$

$${T}_{KV\_trasnfer \_per \_layer} = \frac{2 * b * {h}_{1} * s}{band w {idth}_{interconnect}}$$

$${Weights}_{trasnformer\_per \_layer} = 4 * {h}_{1}^{2} * b * s + 2 * {h}_{1} * {h}_{2} * b * s$$

$${T}_{prefill\_compute \_per \_layer} = \frac{linear\_layer}{mm\_flops} + \frac{Att}{bmm\_flops} = \frac{4 b s {h}_{1}^{2} + 2 b s {h}_{1} {h}_{2}}{mm\_flops} + \frac{2 b h {h}_{1} {s}^{2}}{{bmm\_}_{} flops}$$

$${AveKVCache}_{decode layer} = 2 * b * {h}_{1} * ( s + \frac{n}{2} )$$

$${T}_{decode computer per layer} = \frac{linear\_layer}{mm\_flops} + \frac{Att}{bmm\_flops} = \frac{4 b s {h}_{1}^{2} + 2 b s {h}_{1} {h}_{2}}{mm\_flops} + \frac{2 b h {h}_{1} ( s + \frac{n}{2} )}{{bmm\_}_{} flops}$$

$$Equation Set 2 : Example FP 16 cost function algorithm$$

$${KVCache}_{token} = 4 * l * {h}_{1}$$

$${T}_{KV\_transfer \_per \_layer} = \frac{4 * b * {h}_{1} * s}{band w {idth}_{interconnect}}$$

$${Weights}_{trasnformer per layer} = 8 * {h}_{1}^{2} * b * s + 4 * {h}_{1} * {h}_{2} * b * s$$

$${T}_{prefill\_compute \_per \_layer} = \frac{linear\_layer}{mm\_flops} + \frac{Att}{bmm\_flops} = \frac{8 b s {h}_{1}^{2} + 4 b s {h}_{1} {h}_{2}}{mm\_flops} + \frac{4 b h {h}_{1} {s}^{2}}{bmm\_flops}$$

$${memory}_{r e q u i rement} = 2 * ( 4 * {h}_{1}^{2} + 2 * {h}_{1} * {h}_{2} ) * l$$

where mm_flops is the processor flops/second for matrix multiplication,
bmm_flops is the processor flops/second for batched matrix multiplication,
s is the input sequence length,
n is the output sequence length,
h₁ is the hidden size,
h₂ is the hidden size of the second MLP layer,
l is the number of layers, and
b is the batch size.

Turning now to the figures, FIG. 1 is an illustration of a diagram of example KV pair flow 100 for offloading and reloading. KV pair flow 100 shows KV pairs stored in a GPU cache in a box 110. Using the algorithm of the KV hierarchy, the process can determine which KV pairs can be moved off of the GPU to a different memory location. A memory location 115 (e.g., storage location) can be different processors, a memory stack, a solid-state drive (SSD), or other memory storage devices. A box 120 shows the KV pairs being reloaded to the GPU cache as they are requested by the LLM processing.

FIG. 2 is an illustration of diagrams of example graphs 200. Graphs 200 includes a graph 210 which shows a demonstration of the disclosed processes on an A100 GPU and a graph 230 which shows a demonstration of the disclosed processes on an H100 GPU. Graph 210 has an x-axis 215 indicating the number of tokens in thousands of tokens (k) and a y-axis 216 indicating the bandwidth in gigabytes per second (GB/s). The standard PCIe bus bandwidth is indicated by line 220. Graph 230 has an x-axis 235 indicating the number of tokens in thousands of tokens (k) and a y-axis 236 indicating the bandwidth in gigabytes per second (GB/s). The standard PCIe bus bandwidth is indicated by line 240.

Graph 210 shows that transferring a KV pair from an off-processor memory location to the GPU will result in a faster operation than re-computing the KV pair since the PCIe communication channel has available bandwidth. Graph 230 shows there is a potential bandwidth bottleneck (indicated by an oval 245), so it can be more efficient to re-compute KV pairs rather than store them off the processor as the processor memory capacity is filled. As the number of tokens increases, the amount of time to re-compute each of the KV pairs can exceed the communication bandwidth constraint at which point storing and reloading the KV pairs becomes the better process for improving the overall performance of the LLM.

FIG. 3 is an illustration of a diagram of an example graph 300 demonstrating the performance of the disclosed processes. Graph 300 shows sample results from a test system. As the number of tokens, e.g., KV pairs, increases, the re-computation costs increase faster than the KV pair reload process from an off-processor location. In addition, graph 300 shows that the cost models provide an estimate that is close to the actual values, thereby showing the cost models are a reliable indicator for the processes to utilize.

Graph 300 has an x-axis 305 indicating the number of input tokens and a y-axis 306 indicating the time in seconds to process the KV pair request. A key 307 describes the four data plots on graph 300.

FIG. 4 is an illustration of a diagram of an example graph 400 demonstrating the relative time frames for storing KV pairs. The time frames can utilize a KV pair re-reference interval. If the re-reference interval for reuse of a KV pair is “immediate” then the KV pair can be stored locally in the processor's KV cache (e.g., on-processor KV cache). If the re-reference interval for reuse is delayed a little, the KV pair can be classified as “short-term” and be stored in a location that is accessible, such as a second processor's cache. If the re-reference interval for reuse of a KV pair is a large time interval, then the KV pair can be classified as “long-term” and the KV pair can be stored in longer-term storage, such as a memory stack or SSD (e.g., off-processor KV cache). If the KV pair is not likely to be reused, then the KV pair can be classified as “no reuse” and be discarded.

FIG. 5 is an illustration of a diagram of an example scenario flow 500. Scenario flow 500 shows three scenarios for storing a KV pair. A scenario 510 demonstrates storing a KV pair in the processor KV cache (in this scenario, a GPU processor). A scenario 520 demonstrates storing a KV pair in a second processor cache (moving the KV pair from the primary processor cache). A scenario 530 demonstrates storing the KV pair in more distant memory locations or discarding the KV pair.

FIG. 6 is an illustration of a flow diagram of an example method 600 to use a KV hierarchy process to manage KV pairs during the processing of an LLM with a multi-turn interaction framework. Method 600 can be performed on a computing system, for example, KV hierarchy system 700 of FIG. 7 or KV hierarchy controller 800 of FIG. 8. The computing system can be one or more processors in various combinations (e.g., CPUs, GPUs, SIMDs, or other types of processors), a data center, a cloud environment, a server, a laptop, a mobile device, a smartphone, a PDA, or other computing system capable of compiling code for a targeted processing unit. Method 600 can be encapsulated in software code or hardware, for example, an application, code library, code module, dynamic link library, module, function, RAM, ROM module, and other software and hardware implementations. The software can be stored in a file, database, or other computing system storage mechanism. Method 600 can be partially implemented in software and partially in hardware. Method 600 can perform the steps for the described processes, for example, managing KV pairs and storing them in local, near, or distant storage areas as determined by the optimization cost algorithms.

Method 600 starts at a step 605 and proceeds to a step 610. In step 610, KV caches can be identified. In some aspects, there can be more than one KV cache on the primary processor. In some aspects, there can be one or more caches on one or more secondary processors. In some aspects, there can be one or more caches on one or more other types of processing chips. In some aspects, there can be one or more caches on one or more memory stacks. In some aspects, there can be one or more caches on other storage devices, for example, SSDs.

In a step 615, The KV hierarchy process needs to know where each KV cache is located, the approximate memory capacity of each cache (e.g., available memory capacity of the processor unit, available memory capacity of other processor units, available memory capacity of a memory stack, or available memory capacity of an SSD), and the approximate cost for retrieval from each cache. The available memory capacity of each KV cache is determined by the memory size allocated to the KV cache. Within this information, the KV hierarchy process can manage the storage of the KV pairs that are computed for the LLM processing. Steps 610 and 615 can be implemented at the start of a LLM processing session. These steps do not need to be repeated unless the process determines a change in the status of a cache is warranted.

In a step 620, the LLM can be processed by the processor. Input data can be analyzed by the LLM resulting in one or more KV pairs being computed. The LLM utilizes a multi-turn interaction framework.

In a step 625, during each turn of the LLM, the computed KV pairs can be stored. Currently used KV pairs can be stored in the local cache of the processor. In a step 630, if the capacity is reached of the cache, KV pairs that are not being used can be moved to another memory location or discarded. The KV hierarchy can utilize the KV pair information with the KV cache information gathered in step 610 to which KV cache the KV pair will be directed or discarded.

In a step 635, if on a subsequent turn of the LLM processing, the KV pair previously moved to an off-processor KV cache is requested, that KV pair can be reloaded to the processor cache and treated as if it was recently computed, e.g., other KV pairs can be moved out of the processor KV cache to make capacity space for the reloaded KV pair. In some aspects, if the KV pair is not available, the KV pair can be re-computed. In some aspects, if the KV pair would take too long to retrieve from a distant KV cache, the KV pair can be re-computed. The KV hierarchy process can manage these decisions using one or more cost models, such as shown in Equation Set 1 and Equation Set 2. Method 600 ends at a step 695.

FIG. 7 is an illustration of a block diagram of an example KV hierarchy system 700. KV hierarchy system 700 can be implemented in one or more computing systems or one or more processors. In some aspects, KV hierarchy system 700 can be implemented using a KV hierarchy controller such as KV hierarchy controller 800 of FIG. 8. KV hierarchy system 700 can implement one or more aspects of this disclosure, such as method 600 of FIG. 6.

KV hierarchy system 700, or a portion thereof, can be implemented as an application, a code library, a dynamic link library, a function, a module, a header file, other software implementation, or combinations thereof. In some aspects, KV hierarchy system 700 can be implemented in hardware, such as a ROM, a graphics processing unit, or other hardware implementation. In some aspects, KV hierarchy system 700 can be implemented partially as a software application and partially as a hardware implementation. KV hierarchy system 700 is a functional view of the disclosed processes, and an implementation can combine or separate the described functions in one or more software or hardware systems.

KV hierarchy system 700 includes a data transceiver 710, a KV hierarchy processor 720, and a result transceiver 730. The output, e.g., the determination of where to store a KV pair, can be communicated to a data receiver, such as one or more of a processing unit 760 (one or more combinations of processor units or processing cores), one or more memory systems 762 (e.g., L1 cache or L2 cache of chips, or memory stacks), or one or more storage devices 764 (e.g., an SSD).

In some aspects, the results of the KV hierarchy system 700, such as those communicated to the one or more processing units 760, one or more storage devices 764, or one or more memory systems 762, can be retrieved to be reloaded into the processor cache for use in a subsequent turn of the multi-turn interaction framework during processing of the LLM.

Data transceiver 710 can receive the input parameters, including the number and type of KV caches on the processor, the number and type of caches on other processors or chips (e.g., processing unit 760), or the number and type of KV caches in the memory systems (e.g., one or more memory systems 762). The input parameters include the usage pattern of the KV pair and whether there is an estimate of whether the KV pair will be used again, and in an approximate number of turns. The input parameters include the KV pairs to be adjudicated. In some aspects, data transceiver 710 can be part of KV hierarchy processor 720.

Result transceiver 730 can communicate one or more outputs (e.g., KV pairs), to one or more data receivers, such as processing unit 760, one or more memory systems 762, one or more storage devices 764, or other related systems, whether located proximate result transceiver 730 or distant from result transceiver 730. Data transceiver 710, KV hierarchy processor 720, and result transceiver 730 can be, or can include, conventional interfaces configured for transmitting and receiving data. Data transceiver 710, KV hierarchy processor 720, or result transceiver 730 can be implemented as software components, for example, a virtual processor environment, as hardware, for example, circuits of an integrated circuit, or combinations of software and hardware components and functionality. The functionality described for these components remains intact regardless of how the functionality is implemented.

KV hierarchy processor 720 (e.g., one or more processing units such as processor 830 of FIG. 8) can implement the analysis and algorithms as described herein utilizing the input parameters. In some aspects, KV hierarchy processor 720 can be a KV hierarchy unit, capable of determining a storage location of the one or more KV pairs, wherein the storage location can be one of the KV cache of the processing unit, a second processor KV cache, or a memory unit KV cache, wherein the KV hierarchy utilizes a re-compute cost function and a reload cost function.

KV hierarchy processor 720 can be one or more code functions or routines executing on a processor, a dedicated hardware component, a multicore processor, a multiprocessor system, or a streaming multiprocessor. KV hierarchy processor 720 can be implemented by a CPU, a GPU, or other types of processors. KV hierarchy processor 720 can work with or can include a KV cache system that can manage the KV pair hierarchy and KV pair storage. KV hierarchy processor 720 can work with or can include a code execution system, for example a processor unit code execution system.

A memory or data storage system of KV hierarchy processor 720 (such as a core cache, L1 cache, L2 cache, or other memory systems, e.g., memory units) can be configured to store the processes and algorithms for directing the operation of KV hierarchy processor 720. KV hierarchy processor 720 can include a processor that is configured to operate according to the analysis operations and algorithms disclosed herein, and an interface to communicate (transmit and receive) data.

FIG. 8 is an illustration of a block diagram of an example of a KV hierarchy controller 800 according to the principles of the disclosure. KV hierarchy controller 800 can be stored on one computer or multiple computers. The various components of KV hierarchy controller 800 can communicate via wireless or wired conventional connections. A portion or a whole of KV hierarchy controller 800 can be located at one or more locations. In some aspects, KV hierarchy controller 800 can be part of another system (e.g., processor, core, server, or other systems), and can be integrated with one device, such as a part of a processing system. KV hierarchy controller 800 represents a demonstration of the functionality employed for the disclosure, and implementations can use a variety of devices, for example, circuits of a processor, dedicated processors, virtual systems, servers, other computing or processing systems, be in software or hardware, or various combinations thereof.

KV hierarchy controller 800 can be configured to perform the various functions disclosed herein including receiving input parameters and generating results from the execution of the methods and processes described herein, such as determining where a KV pair should be stored or if the KV pair should be discarded. KV hierarchy controller 800 includes a communications interface 810, a memory 820, and a processor 830.

Communications interface 810 is configured to transmit and receive data. For example, communications interface 810 can receive the input parameters. Communications interface 810 can transmit the output or interim outputs. In some aspects, communications interface 810 can transmit a status, such as a success or failure indicator of KV hierarchy controller 800 regarding receiving the various inputs, transmitting the generated outputs, or producing the results.

In some aspects, processor 830 can perform the operations as described by KV hierarchy processor 720. Communications interface 810 can communicate via communication systems used in the industry. For example, wireless or wired protocols can be used. Communication interface 810 is capable of performing the operations as described for data transceiver 710 and result transceiver 730 of FIG. 7.

Memory 820 can be configured to store a series of operating instructions that direct the operation of processor 830 when initiated, including supporting code representing the algorithm for implementing the KV hierarchy process. Memory 820 is a non-transitory computer-readable medium. Multiple types of memory can be used for the data storage systems and memory 820 can be distributed.

Processor 830 can be one or more processors. Processor 830 can be a combination of processor types, such as a CPU, a GPU, a single instruction multiple data (SIMD) processor, or other processor types. Processor 830 can be a virtual process supported by a processing unit. Processor 830 can be dedicated circuitry within a processor. Processor 830 can be a code process running on a processor. Processor 830 can be configured to produce the output, one or more interim outputs, and statuses utilizing the received inputs. Processor 830 can determine the output using parallel processing.

Processor 830 can be an integrated circuit. In some aspects, processor 830, communications interface 810, memory 820, or various combinations thereof, can be an integrated circuit. Processor 830 can be configured to direct the operation of KV hierarchy controller 800. Processor 830 includes the logic to communicate with communications interface 810 and memory 820, and perform the functions described herein. Processor 830 is capable of performing or directing the operations as described by KV hierarchy processor 720 of FIG. 7. In some aspects, KV hierarchy system 700 can work with a processing unit system, be part of a processing unit system, or include a processing unit system. In some aspects, KV hierarchy system 700 or KV hierarchy controller 800 can be part of a machine learning system.

A portion of the above-described apparatus, systems or methods may be embodied in or performed by various digital data processors or computers, wherein the computers are programmed or store executable programs of sequences of software instructions to perform one or more of the steps of the methods. The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, or functions, systems or apparatuses described herein. The data storage media can be part of or associated with digital data processors or computers.

The digital data processors or computers can be comprised of one or more GPUs, one or more CPUs, one or more other processor types, or a combination thereof. The digital data processors and computers can be located proximate to each other, proximate to a user, in a cloud environment, a data center, or located in a combination thereof. For example, some components can be located proximate to the user, and some components can be located in a cloud environment or data center.

The GPUs can be embodied on one semiconductor substrate, included in a system with one or more other devices such as additional GPUs, a memory, and a CPU. The GPUs may be included on a graphics card that includes one or more memory devices and is configured to interface with a motherboard of a computer. The GPUs may be integrated GPUs (iGPUs) that are co-located with a CPU on one chip. Configured or configured to means, for example, designed, constructed, or programmed, with the necessary logic and/or features for performing a task or tasks.

Portions of disclosed examples or embodiments may relate to computer storage products with a non-transitory computer-readable medium that has program code thereon for performing various computer-implemented operations that embody a part of an apparatus, device or carry out the steps of a method set forth herein. Non-transitory used herein refers to all computer-readable media except for transitory, propagating signals. Examples of non-transitory computer-readable media include but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Examples of program code include both machine code, such as produced by a compiler, and files containing higher-level code that may be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Those skilled in the art to which this application relates will appreciate that other and further additions, deletions, substitutions, and modifications may be made to the described embodiments. It is also to be understood that the terminology used herein is for the purpose of describing particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

What is claimed is:

1. A method, comprising:
identifying two or more key-value (KV) caches capable of storing KV pairs;
implementing a KV hierarchy for the two or more KV caches, where at least one KV cache of the two or more KV caches is located on a processor and another KV cache of the two or more KV caches is located off the processor; and
processing a large language model (LLM) using a multi-turn interaction framework, wherein the processing computes the KV pairs and the KV pairs are used by the LLM in determining an LLM result, further comprising:
storing the KV pairs being used for a current turn interaction in the at least one KV cache located on the processor;
freeing a memory capacity of the at least one KV cache located on the processor, using the KV hierarchy, through identifying a subset of KV pairs from the KV pairs to be removed from the at least one KV cache located on the processor; and
reloading at least one KV pair from the subset of KV pairs to the at least one KV cache located on the processor at a time when the processing needs the at least one KV pair for the current turn interaction.

2. The method as recited in claim 1, wherein the freeing the memory capacity further comprises:
offloading the subset of KV pairs to a memory location off of the processor.

3. The method as recited in claim 1, wherein the freeing the memory capacity further comprises:
discarding the subset of KV pairs.

4. The method as recited in claim 3, wherein the processing the LLM further comprises:
re-computing a previously discarded KV pair.

5. The method as recited in claim 1, wherein a memory size allocated to the at least one KV cache located on the processor is determined by the memory capacity available on the processor.

6. The method as recited in claim 1, wherein the KV hierarchy further comprises:
calculating a re-computation cost of a candidate KV pair of the KV pairs;
calculating a reload cost of the candidate KV pair from the at least one KV cache located off the processor;
estimating a likelihood of reuse of the candidate KV pair by the LLM; and
determining whether the candidate KV pair is included in the subset of KV pairs, discarded, or remains in the at least one KV cache located on the processor.

7. The method as recited in claim 1, wherein the freeing the memory capacity further comprises:
identifying one or more KV pairs stored in the at least one KV cache located off the processor to be moved to a second KV cache located off the processor.

8. The method as recited in claim 1, wherein the freeing memory capacity further comprises:
identifying one or more KV pairs stored in the at least one KV cache located off the processor to be discarded.

9. The method as recited in claim 1, wherein the processor is a graphics processing unit (GPU) and the at least one KV cache located off the processor is located on a central processing unit (CPU).

10. The method as recited in claim 1, wherein the KV hierarchy utilizes a KV pair re-reference interval in determining a storage location for a KV pair in the KV pairs.

11. The method as recited in claim 10, wherein the KV pair re-reference interval is immediate, and the storage location is the at least one KV cache located on the processor.

12. The method as recited in claim 10, wherein the KV pair re-reference interval is short-term and the storage location is the at least one KV cache located off the processor, and the storage location is on a second processor.

13. The method as recited in claim 10, wherein the KV pair re-reference interval is long-term and the storage location is the at least one KV cache located off the processor, and the storage location is a memory stack.

14. The method as recited in claim 10, wherein the KV pair re-reference interval is no reuse and the KV pair is discarded.

15. A system, comprising:
a memory unit, capable of storing one or more key-value (KV) pairs in at least one off-processor KV cache; and
a processing unit capable of executing code to process a large language model (LLM) using a multi-turn interaction framework, wherein the processing unit is communicatively coupled to the memory unit, and further comprises:
an on-processor KV cache capable of storing the one or more KV pairs; and
a KV hierarchy unit capable of evaluating each KV pair in the one or more KV pairs to determine a movement of the each KV pair to remain in the on-processor KV cache, to move to the memory unit, or to be discarded.

16. The system as recited in claim 15, wherein the movement is determined by a re-compute cost model and a reload cost model applied to the each KV pair.

17. The system as recited in claim 15, wherein the processor unit is a graphics processing unit (GPU), and the memory unit is located in a secondary processing chip.

18. The system as recited in claim 15, wherein the memory unit is located in a memory stack.

19. The system as recited in claim 15, wherein the memory unit is located in a solid-state drive (SSD).

20. A non-transitory computer program product having a series of operating instructions stored on a non-transitory computer-readable medium that directs a key-value (KV) hierarchy when executed thereby to perform operations, the operations comprising:
identifying two or more KV caches capable of storing KV pairs;
implementing the KV hierarchy for the two or more KV caches, where at least one KV cache of the two or more KV caches is located on a processor and another KV cache of the two or more KV caches is located off the processor; and
processing a large language model (LLM) using a multi-turn interaction framework, wherein the processing computes the KV pairs and the KV pairs are used by the LLM in determining an LLM result, further comprising:
storing the KV pairs being used for a current turn interaction in the at least one KV cache located on the processor;
freeing memory capacity of the at least one KV cache located on the processor, using the KV hierarchy, through identifying a subset of KV pairs from the KV pairs to be removed from the at least one KV cache located on the processor; and
reloading at least one KV pair from the subset of KV pairs to the at least one KV cache located on the processor at a time when the processing needs the at least one KV pair for the current turn interaction.

21. The non-transitory computer program product as recited in claim 20, wherein the KV hierarchy further comprises:
calculating a re-computation cost of a candidate KV pair of the KV pairs;
calculating a reload cost of the candidate KV pair from the at least one KV cache located off the processor;
estimating a likelihood of reuse of the candidate KV pair by the LLM; and
determining whether the candidate KV pair is included in the subset of KV pairs, discarded, or remains in the at least one KV cache located on the processor.

22. A processing unit, comprising:
a code execution module, capable of processing input data to a large language model (LLM) and generating an output of the LLM, wherein the LLM utilizes a multi-turn interaction framework;
a processor memory capable of storing one or more key-value (KV) pairs computed by the LLM in a KV cache; and
a KV hierarchy system, capable of determining a storage location of the one or more KV pairs, wherein the storage location can be one of the KV cache of the processing unit, a second processor KV cache, or a memory unit KV cache, wherein the KV hierarchy utilizes a re-compute cost function and a reload cost function.

23. The processing unit as recited in claim 22, wherein the processing unit is a graphics processing unit (GPU).

24. A processing unit system, comprising:
a code execution system, capable of processing input data to a large language model (LLM) and generating an output of the LLM, wherein the LLM utilizes a multi-turn interaction framework;
a key-value (KV) cache system, part of a first processor, capable of storing one or more KV pairs computed by the LLM; and
a KV hierarchy system, capable of determining a storage location of the one or more KV pairs, wherein the storage location can be one of a first processor KV cache, a second processor KV cache, or a memory unit KV cache, wherein the KV hierarchy utilizes a re-compute cost function and a reload cost function.

25. The processing unit system as recited in claim 24, wherein the KV hierarchy system further comprises:
calculating a re-computation cost of a candidate KV pair of the KV pairs;
calculating a reload cost of the candidate KV pair from the second processor KV cache or the memory unit KV cache;
estimating a likelihood of reuse of the candidate KV pair by the LLM; and
determining whether the candidate KV pair is included in the subset of KV pairs, discarded, or remains in the first processor KV cache.
